(19) United States
(12) Patent Application Publication
(10) Pub. No.: US 2004/0099102 A1
(43) Pub. Date: May 27, 2004

(54) Adaptive hexagonal driving tool

(76) Inventor: Bill S. Vaughan, San Juan Capistrano, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/302,152

(22) Filed: Nov. 21, 2002

(51) Int. Cl. B25B 13/00

(52) U.S. Cl. 81/124.4

(57) ABSTRACT

A hand tool apparatus has an elongate handle providing a uniform hexagonally shaped surface terminating at its ends with right surfaces. The right surfaces each have plural hexagonally shaped sockets of diminishing size formed in them. Plural transverse hexagonal through holes are formed in the hexagonal surface of the handle, and plural hexagonal rods may be slidingly engaged within the through holes and mounted in the sockets.

### BACKGROUND OF THE INVENTION

INCORPORATION BY REFERENCE: Applicant(s) hereby incorporate herein by reference, any and all U.S. patents, U.S. patent applications, and other documents and printed matter cited or referred to in this application.

### FIELD OF THE INVENTION

This invention relates generally to hand tools for driving fasteners and more particularly to an adaptive hand tool having plural drive shafts and hexagonal sockets and holes in a handle portion of the tool.

### DESCRIPTION OF RELATED ART

The following art defines the present state of this field:

Hu, U.S. Pat. No. 6,367,628 teaches a tool holder device comprising a main board, a slide seat releasably engaged with the main board and including a plurality of pegs, and a tool holder including a plurality of receptacles with different diameters for releasably holding wrenches of various sizes. The tool holder is releasably engaged with the slide seat. Each receptacle includes a resilient holding member for releasably holding an associated wrench in place. When the tool holder is engaged with the slide seat, each peg of the slide seat is received in an associated receptacle of the tool holder, and a wrench received in the tool holder rests on an associated peg with the wrench being not held by an associated holding means, thereby allowing ready removal of the wrench from the tool holder.

Legg, U.S. Pat. No. 6,109,147 teaches a tool providing a plurality of tool bits, each having a different polygonal (i.e. hexagonal) external contour. The tool includes an inner member and an outer sleeve member. The inner member defines a small tool bit having a polygonal external contour. The outer sleeve member includes a cavity that selectively receives the inner member. The inner member and the outer sleeve member together define, when the inner member is received within the cavity, a large tool bit having a polygonal external contour of the same shape, but a larger size, than the inner tool bit. In this manner, the small tool bit may be used when the inner member is withdrawn from the cavity and the large tool bit may be used when the inner member is received within the cavity.

Hu, U.S. Pat. No. 5,938,028 teaches a tool holder including a main body having a bottom wall and a number of substantially L-shaped separation walls formed on the bottom wall, thereby defining a substantially L-shaped receiving compartment between each two adjacent separation walls. Each separation wall includes a first section and a second section. A resilient retaining member is mounted on the first section of each separation wall. Each receiving compartment includes a relatively longer section and a relatively shorter section. A guiding wall is extended across two second sections respectively of two adjacent separation walls. The guiding wall includes a downwardly extending guiding surface that faces the bottom wall. The downwardly extending guiding surface is preferably arcuate and inclines downwardly toward the bottom wall. The bottom wall includes a guiding surface section that is located below the downwardly extending guiding surface of the guiding wall and inclines downwardly along a direction parallel to the extending direction of the downwardly extending guiding surface of the guiding wall. The main body further includes a retaining wall provided to the relatively shorter section of each receiving compartment. The lower retaining wall includes an inner holding surface that faces the bottom wall. The bottom wall includes a holding surface section located above the guiding surface section. The downwardly extending guiding surface of the guiding wall and the guiding surface section of the bottom wall together guide a hexagonal wrench to be received in an associated receiving compartment. The inner holding surface of the retaining wall, the holding surface section of the bottom wall, and the retaining member together hold the hexagonal wrench in place.

The prior art teaches tool holders for hex wrenches but does not teach a combination handle and hex wrench tool set capable of improved adaptation for long reach and application of torque manually or by drivers. The present invention fulfills these needs and provides further related advantages as described in the following summary.

### SUMMARY OF THE INVENTION

The present invention teaches certain benefits in construction and use which give rise to the objectives described below.

A hand tool apparatus has an elongate handle providing a uniform hexagonally shaped surface terminating at its ends with right surfaces. The right surfaces each have plural hexagonally shaped sockets of diminishing size formed in them. Plural transverse hexagonal through holes are formed in the hexagonal surface of the handle, and plural hexagonal rods may be slidingly engaged within the through holes and mounted in the sockets.

A primary objective of the present invention is to provide an apparatus and method of use of such apparatus that provides advantages not taught by the prior art.

Another objective is to provide such an invention capable of driving a range of hexagonal socket head fasteners.

A further objective is to provide such an invention comprising an elongate handle and plural hex rods of various sizes wherein any one of the rods may be mounted axially or transversely in the handle.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of the preferred embodiment of the invention including a handle and a plurality of driver rods;

FIG. 2 is a sectional view thereof taken along line 2-2 in FIG. 1;

FIGS. 3 and 4 are perspective views thereof showing uses of the invention.

### DETAILED DESCRIPTION OF THE INVENTION

The above described drawing figures illustrate the invention in at least one of its preferred embodiments, which is further defined in detail in the following description.

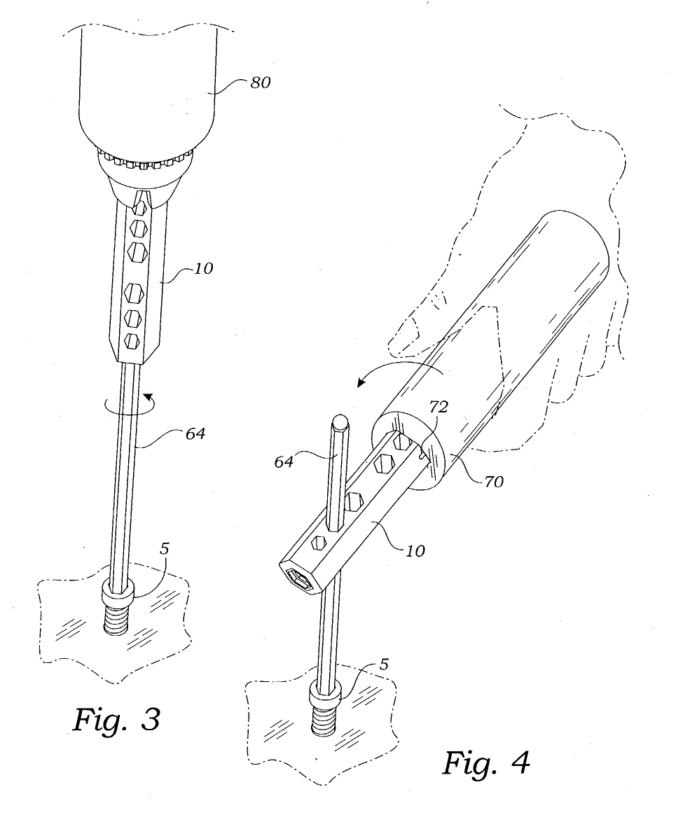

The present invention is a hand tool apparatus as shown in operation in FIGS. 3 and 4 of the attached drawings. Preferably the apparatus is made of a rigid and durable material such as steel. The tool has an elongate handle 10, of between 4 and 8 inches in length, providing an outer surface 12, preferably of a uniform hexagonal shape, but which may have other conformations, such as square or rectangular; in cross-section. The handle 10 terminates at a proximal right surface 20 at one end of the handle 10, and at a distal right surface 30 at the other end of the handle 10. The proximal and distal right surfaces 20, 30, each have, at lest one, and preferably plural hexagonally shaped sockets 40, 42, 44 of diminishing size formed in them, as is best seen in FIG. 2. At least one, and preferably plural transverse hexagonal through holes 50-55 of sequentially diminishing sizes are also formed in the handle 10. Preferably, the through holes are arranged in parallel juxtaposition providing the advantage of easier selection and placement of hex rods, defined in the following.

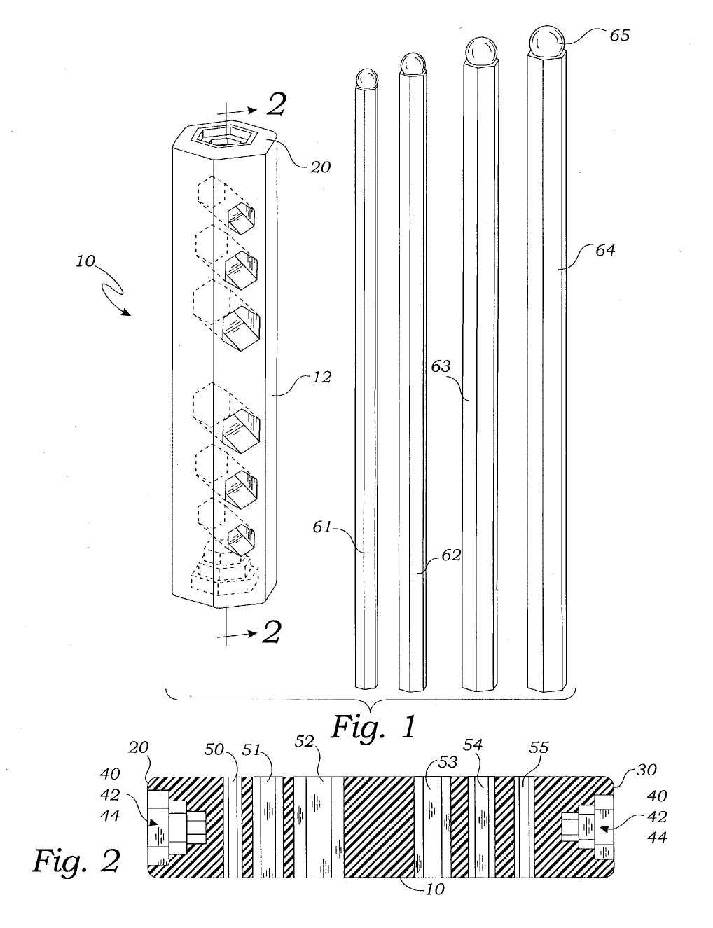

Further, the apparatus provides plural hexagonal rods 61-64 (hex rods) of sequentially diminishing size for sliding engagement within the through holes, 50-55, that is, each of the rods 61-64 is adapted by its size to fit in tight sliding engagement within at least one of the holes 50-55. The rods 61-64 also are able to mount into the sockets 40, 42, 44. The hex rods 61-64 preferably have a rounded end 65 as is well known in the art, and shown in FIG. 1, so as to facilitate the entry of an end of the rod into a hexagonal socket of a fastener 5 (not a part of the present invention) as shown in FIGS. 3 and 4. The sockets 40, 42, 44 and the through holes 50-55, as well as the corresponding hex rods 61-64 may be of any desired size and, as a set, may employ, for instance, both U.S. customary sizes as well as metric sizes, i.e., U.S. at one end and metric at the opposing end. In order to reach into deep recesses, the hex rods 61-64 are preferably between 2 and 10 inches in length.

Preferably the apparatus further comprises an elongate extender rod 70 providing a hexagonal hole 72 therein sufficient for accepting the elongate handle 10 in axial alignment so as to achieve greater turning leverage, as shown in FIG. 4.

The hex rods 61-64 are of sufficient length as to provide extensive reach, i.e., at least six inches in length, and preferably greater. Thus, the present apparatus provides a means for driving a range of hex cap head screws and equivalent fasteners, provides axial mounting for low torque applications or where a power driver 80 (FIG. 3) is used; provides transverse mounting (FIG. 4) for improved manual torque application; and provides an extender handle 70 for even greater manual torque application, as shown by the arrows in FIGS. 3 and 4.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A hand tool apparatus combination comprising: (a) an elongate handle providing a uniform hexagonally shaped surface terminating at a proximal right surface at one end of the handle, and at a distal right surface at another end of the handle; the proximal and distal right surfaces each defining at least one hexagonally shaped socket therein; the hexagonally shaped surface of the elongate handle defining at least one transverse hexagonal through hole therein; and (b) at least one hexagonal rod engaged within one of the at least one through hole and the at least one socket.

2. The apparatus of claim 1 wherein the at least one hexagonally shaped socket comprises plural abutting, axially aligned, hexagonally shaped sockets of sequentially diminishing size at, at least one of the proximal and distal right surfaces.

3. The apparatus of claim 1 wherein the at least one transverse hexagonal through hole comprises plural side-by-side, hexagonally shaped through holes of sequentially diminishing sizes.

4. The apparatus of claim 3 wherein the through holes are arranged in parallel juxtaposition.

5. The apparatus of claim 1 wherein the at least one hexagonal rod comprises a plurality of hexagonally shaped rods of sequentially diminishing size.

6. The apparatus of claim 1 further comprising an elongate extender rod providing a hexagonal hole therein sufficient for accepting the elongate handle in axial alignment and extension.

7. A hand tool apparatus combination comprising: (a) an elongate handle providing a uniform hexagonally shaped surface terminating at a proximal right surface at one end of the handle, and at a distal right surface at another end of the handle; the proximal and distal right surfaces each defining a plurality of hexagonally shaped sockets therein; the hexagonally shaped surface of the elongate handle defining a plurality of transverse hexagonal through hole therein; and (b) a plurality of hexagonal rods sized for engagement with both the through holes and the sockets.

8. The apparatus of claim 7 wherein the sockets at the proximal end of the handle are of a metric size, and the sockets at the distal end of the handle are of a U.S. customary size.

9. The apparatus of claim 7 wherein the through holes comprise sizes including both metric and customary US sizes.

10. The apparatus of claim 7 wherein the hexagonal rods comprise sizes including both metric and customary US sizes.

11. A hand tool apparatus combination comprising: (a) an elongate handle providing a uniform hexagonally shaped surface terminating at a proximal right surface at one end of the handle, and at a distal right surface at another end of the handle; the proximal and distal right surfaces each defining a plurality of hexagonally shaped sockets therein; and (b) a plurality of hexagonal rods sized for engagement with the sockets.

12. The apparatus of claim 11 wherein the sockets at the proximal end of the handle are of a metric size, and the sockets at the distal end of the handle are of a U.S. customary size.
